(19) United States
(12) Patent Application Publication
(10) Pub. No.: US 2015/0058372 A1
(43) Pub. Date: Feb. 26, 2015

(54) Automated Generation of Actions from Messages

(71) Applicant: Aptify Corporation, Tysons Corner, VA (US)

(72) Inventors: Amith Nagarajan, New Orleans, LA (US); Robert Kihm, Sacramento, CA (US)

(21) Appl. No.: 14/446,926

(22) Filed: Jul. 30, 2014

Related U.S. Application Data
(60) Provisional application No. 61/869,980, filed on Aug. 26, 2013.

(51) Int. Cl. G06F 17/30; H04L 12/58

(52) U.S. Cl. CPC G06F 17/30289; H04L 51/046
USPC 707/758

(57) ABSTRACT

A computer system enables data representing an action to be generated automatically or semi-automatically based on data stored in a message thread. The data representing the action may be processed automatically to perform tasks such as generating a notification of the action to be performed. The data representing the action may be stored within the message thread based on which the action data was generated.

### BACKGROUND

Online social networking systems, such as FaceBook, Twitter, and LinkedIn have experienced a surge in popularity among both personal and business users. Similarly, systems that are not generally classified as social networking systems, such as SalesForce, include messaging features that are widely used by organizations both internally and to communicate externally with leads, customers, vendors, and others. One of the appeals of such systems is that they facilitate communications among users via a wide variety of communication modes (e.g., chat, text messaging, asynchronous messaging (akin to email), and audio messaging, among others) and using nearly any type of computing device (e.g., desktop computer, laptop computer, tablet computer, or smartphone). Another benefit of such systems is that they provide users with access to the history of all messages within each message thread and enable users to search such threads, thereby reducing the need for redundant communications and protecting against loss of information when particular users engaged in a thread become unavailable.

Online messaging systems, however, have a variety of drawbacks. For example, as users use such systems to engage in an increasingly large amount and wide variety of communications, and as the contents of such communications are stored (often permanently), the sheer volume of such information can make it difficult to find relevant information when it is needed. Furthermore, the purpose of most communication within businesses and other organizations is not merely to convey information, but to enable participants in a conversation to act on such information. Conventional messaging systems, however, focus on facilitating the creation, transmission, storage, and retrieval of messages, rather than on facilitating actions. Even when conventional systems are used to communicate regarding actions, managing such actions typically requires a separate task management system (e.g., Microsoft Outlook) or a task management aspect of the same system (e.g., “My Tasks” in Salesforce CRM). Shifting from one system (or aspect of a system) to another can be prohibitively difficult, time-consuming, or even dangerous when additional manual steps are required to create notifications, tasks, or other reminders of the actions needing to be performed.

### SUMMARY

A computer system enables data representing an action to be generated automatically or semi-automatically based on data stored in a message thread. The data representing the action may be processed automatically to perform tasks such as generating a notification of the action to be performed. The data representing the action may be stored within the message thread based on which the action data was generated.

For example, one embodiment of the present invention is directed to a computer-implemented method comprising: (A) receiving input from a sending user; (B) generating a message based on the input; (C) transmitting the message to at least one recipient user; and (D) parsing the input to generate an action data record representing an action to be performed. The input from the sending user may specify a user assigned to the action, and the action data record may contain data representing the user assigned to the action.

The method may further include transmitting a notification of the action data record to the user assigned to the action. The method may further include performing the action represented by the action data record.

Other features and advantages of various aspects and embodiments of the present invention will become apparent from the following description and from the claims.

### BRIEF DESCRIPTION OF THE DRAWINGS

FIG. 1 is a dataflow diagram of a system for creating and managing action data according to one embodiment of the present invention; and

FIG. 2 is a flowchart of a method performed by the system of FIG. 1 according to one embodiment of the present invention.

### DETAILED DESCRIPTION

In general, embodiments of the present invention include techniques for enabling data representing an action to be generated automatically or semi-automatically based on data stored in a message thread. The data representing the action may be processed automatically to perform tasks such as generating a notification of the action to be performed. The data representing the action may be stored within the message thread based on which the action data was generated. In this way, embodiments of the present invention enable message threads to be used as actionable information.

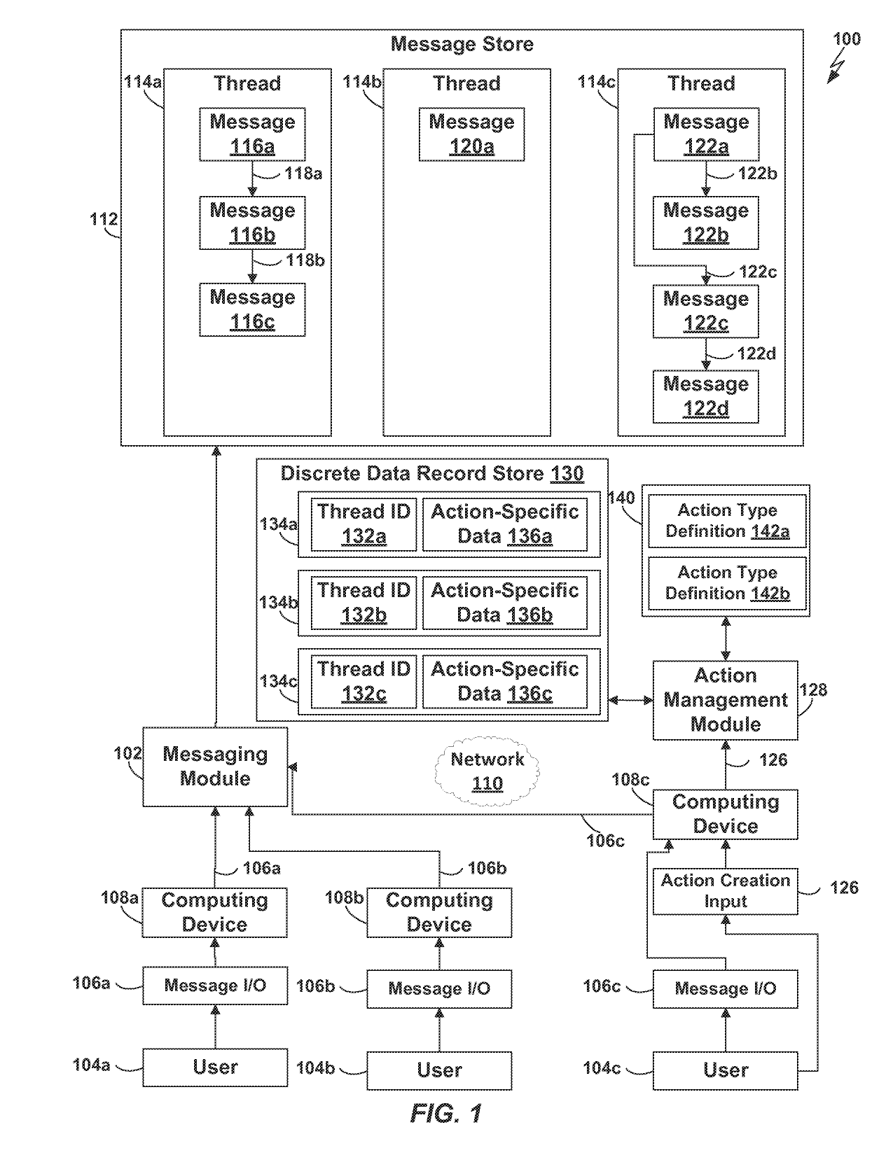

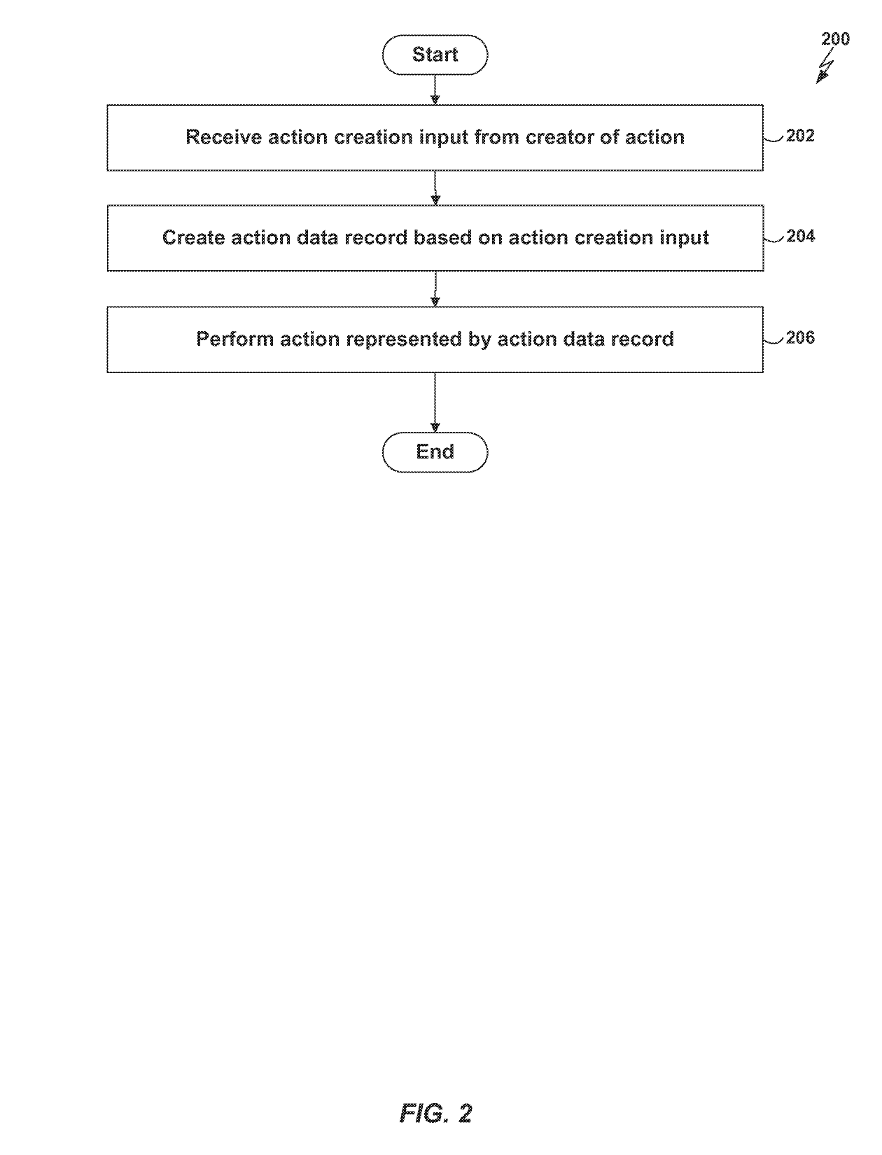

For example, referring to FIG. 1, a dataflow diagram is shown of a system 100 for creating and managing action data according to one embodiment of the present invention. Referring to FIG. 2, a flowchart is shown of a method 200 that is performed by the system 100 of FIG. 1 according to one embodiment of the present invention.

The system 100 includes a messaging module 102, which is used by a plurality of users 104a-c to generate messages and thereby to communicate with each other. Similar to existing instant messaging services such as those offered as part of the social network Facebook or the email service Gmail (provided by Google), users 104a-c may communicate with one another using free-form text in messages. Although three users 104a-c are shown in FIG. 1 for purpose of example, the system 100 may include any number of users. The messaging module 102 may be any kind of module for creating, transmitting, modifying, deleting, and/or otherwise managing messages, such as a social networking server, a text messaging server, a chat server, an email server, a Voice over IP (VoIP) server, or any portion or combination thereof. These particular types of communication are merely examples and do not constitute limitations of the present invention. More generally, the messaging module 102 may be capable of creating, transmitting, modifying, deleting, and/or otherwise managing any types of messages.

In general, the users 104a-c may provide any of a variety of inputs to the messaging module 102, such as input specifying new messages to create and transmit, input indicating that a particular message should be manifested (e.g., displayed or played), input instructing the messaging module 102 to delete a particular message, and/or the like. The messaging module 102 may provide any of a variety of outputs to the users 104a-c, such as output representing the contents of a particular message. For ease of illustration, all such inputs and outputs are shown in FIG. 1 as message inputs/outputs (I/O) 106a-c, where user 104a provides/receives I/O 106a to/from messaging module 102, user 104b provides/receives I/O 106b to/from messaging module 102, and user 104c provides/receives I/O 106c to/from messaging module 102. Message I/O 106a-c may be transmitted over one or more networks, such as network 110 (which may, for example, be the public Internet, a private intranet, or a combination thereof). As shown in FIG. 1, users 104a-c may provide/receive message I/O 106a-c using computing devices 108a-c, respectively. Each of the computing devices 108a-c may be any kind of computing device, such as a desktop computer, laptop computer, tablet computer, or smartphone.

Consider an example in which the message input 106a provided by the user 104a to the messaging module 102 contains: (1) instructions to compose and transmit a new message, (2) the contents of such a message, and (3) metadata to associate with the message, such as an identifier of the recipient of the message and a subject line. In response to receiving such input 106a, the messaging module 102 may create and store a message in accordance with the input 106a in a message store 112. For purposes of example, the message store 112 illustrated in FIG. 1 is shown as containing three message threads 114a-c, each of which contains one or more messages. The particular number of threads and numbers of messages in the threads in FIG. 1 are merely examples and do not constitute limitations of the present invention.

Now assume, for purposes of example, that the message input 106a received from user 104a specifies a new message to be created in a new thread. In response to receiving such input 106a, the messaging module 102 may create thread 114a in the message store 112, and create message 116a, based on the message input 106a, as the first message in the thread 114a.

Now also assume, for purposes of example, that the message input 106b received from user 104b specifies a new message to be created within the same thread 114a as message 116a, as a response to message 116a. In response to receiving such input 106b, the messaging module 102 may create message 116b, based on the message input 106b, as the second message in the thread 114a. Link 118a represents data which indicates the relative sequence of messages 116a and 116b, namely that message 116b follows message 116a in the thread 114a.

Now also assume, for purposes of example, that the message input 106c specifies a new message to be created within the same thread 114a as message 116b, as a response to message 116b. In response to receiving such input 106c, the messaging module 102 may create message 116c, based on the message input 106c, as the third message in the thread 114a. Link 118b represents data which indicates the relative sequence of messages 116b and 116c, namely that message 116c follows message 116b in the thread 114a.

The particular sequence and relationship among messages 116a-c shown in FIG. 1 is merely an example and does not constitute a limitation of the present invention. In general, embodiments of the present invention may be used in connection with any kind of messages generated in any manner by any number and combination of users. Merely as additional examples, FIG. 1 also shows a second thread 114b which consists of a single message 120a, and a third thread 114c which consists of four messages 122a-d, in which messages 122b and 122c are replies to message 122a (as indicated by links 124a and 124b, respectively), and in which message 122d is a reply to message 122c (as indicated by link 124c). Although certain embodiments of the present invention may be described herein in connection with message thread 114a for ease of explanation, any of the techniques disclosed herein may be applied to the other threads 114b-c and to threads not shown or described herein.

One or more of the users 104a-c may determine, based on some information in one of the message threads 114a-c, that a person (whether one of the users 104a-c or someone who is not a user of the system 100) should perform an action. For example, assume that message 116b in thread 114a states that the proposed venue for an upcoming conference is not available. In response to reading such a message, the user 104c (who may, for example, be the organizer of the conference) may determine that it is necessary for a particular person (such as user 104b) to find an alternate venue for the conference.

In response to making such a determination, or for any other reason, the user 104c may provide action creation input 126 to the system 100. In general, the action creation input 126 contains data that is used to create a discrete data record representing an action to be performed. The action creation input 126 may be provided as part of free form text, provided in the same manner that message input 106a, 106b, 106c is provided. However, the action creation input 126 is shown in FIG. 1 as being separate from message input 106a, 106b, 106c for ease of illustration. The free form text may or may not include message input in addition to the action creation input 126. Examples of the contents of the action creation input 126 and of methods for generating the action creation input 126 will be described in more detail below.

The user 104c provides an electronic communication to the computing device 108c similar to the variety of inputs provided by users 104a-c to computing devices 108a-c ultimately for messaging module 102, as described above. The computing device 108c identifies the action creation input 126 in free form text of the electronic communication. The computing device 108c transmits the action creation input 126 (or data derived therefrom) over network 110 to an action management module 128, which receives the action creation input 126 (FIG. 2, operation 202). As discussed below, the system 100 supports multiple types of discrete data records. The action management module 128 identifies a predefined type of discrete data record from among a plurality of predefined types of discrete data records based on the action creation input 126. The action management module 128 creates, from the action creation input 126, a discrete data record 134a of the identified predefined type. The discrete data record represents an action to be performed, as specified by the action creation input (FIG. 2, operation 204). The action management module 128 stores the discrete data record 134a in a discrete data record store 130.

The discrete data record 134a may, for example, contain: (1) a thread identifier (ID) 132a, which contains data representing the message thread (e.g., message thread 114a) associated with the action data record 132a; and (2) action-specific data 136a, which contains additional data associated with the action represented by the discrete data record 134a.

The action management module 128 may generate the thread ID 132a in any of a variety of ways. For example, the action creation input 126 may contain data specifying the message thread to associate with the action, in which case the action management module 128 may generate the thread ID 132a based on the data in the action creation input 126 that specifies the message thread. As another example, the action management module 128 may generate the thread ID 132a automatically. For example, the action management module 128 may determine that the user 104c currently is viewing, responding to, and/or otherwise interacting with a particular message, in which case the action management module 128 may identify the thread containing the particular message, and generate the thread ID 132a to contain data representing the identified thread.

The action management module 128 may generate the action-specific data 136a in any of a variety of ways. For example, the action creation input 126 may contain data specifying the action-specific data 136a, in which case the action management module 128 may generate the action-specific data 136a by copying such data from the action creation input 126 or otherwise generating the action-specific data 136a based on the action creation input 126.

The system 100 may support multiple types of discrete data records. The system 100 may include a set 140 of action type definitions 142a-b, which may specify distinct types of discrete data records. Although two action type definitions 142a-b are shown in FIG. 1 for ease of illustration, the system 100 may include any number of action type definitions 142a-b. Each of the action type definitions 142a-b contains data defining a corresponding discrete data record type. For example, each of the type definitions 142a-b may contain data representing a particular set of fields for use in instances of discrete data records of the corresponding type.

For example, consider a “Follow Up” discrete data record type, the purpose of which is to facilitate the creation of discrete data records representing actions for following up on information contained within a message thread. For example, if a sales representative talks to a prospect and wants someone else on the sales team to follow up with the prospect in two weeks, the sales representative may create an instance of the “Follow Up” discrete data record type to represent such a follow up action. Assume, for purposes of example, that the action type definition 142a contains data defining the “Follow Up” discrete data record type. Such an action type definition 142a may, for example, specify that each “Follow Up” discrete data record is to contain: (1) a contact record specifying one or more people (e.g., one or more of the users 104a-c) who is/are responsible for performing the follow up action represented by the discrete data record; (2) a date field representing the due date for performing the follow up action; and (3) a description field for describing the follow up action to be performed.

When a particular instance of a “Follow Up” discrete data record is created, the action management module 128 may create the action-specific data within that instance based on the action type definition 142a for the “Follow Action” discrete data record type. For example, the action creation input 126 provided by the user 104c to the action management module 128 may contain data indicating the type of the discrete data record to create. Assume, for example, that the action creation input 126 contains data indicating that an instance of a “Follow Up” action should be created. In response to receiving such input 126, the action management module 128 may create the discrete data record 134a, as described above, and populate the action-specific data 136a with the fields specified by the “Follow Up” action type definition 142a (e.g., fields for storing a contact, a date, and a description). The action creation input 126 may also contain data representing the values of one or more of the fields of the specified discrete data record type. For example, if the action creation input 126 specifies that a “Follow Up” discrete data record is to be created, the action creation input 126 may also contain data representing the contents of the contact, date, and description to be stored in the discrete data record once it is created. The action management module 128 may use such data in the action creation input 126 to populate the fields in the action-specific data 136a of the created discrete data record 134a.

As another example, consider a “Notify” discrete data record type, the purpose of which is to facilitate the creation of discrete data records that are to be used to notify specified people of particular message threads. Assume, for purposes of example, that the action type definition 142b contains data defining the “Notify” discrete data record type. Such an action type definition 142b may, for example, specify that each “Notify” discrete data record is to contain a person field specifying a person (e.g., one of the users 104a-c) who is to be notified of the message thread associated with the “Notify” discrete data record.

For example, assume that the discrete data record 134b is an action data record of the “Notify” type that is associated with thread 114b. In this case, the thread ID 134b of the record 134a may represent the thread 114b, and the action-specific data 136b of the record 134b may contain the person field specified by the “Notify” action type definition 142b. If, for example, the action creation input 126 provided by the user 104c to the action management module 128 contains data indicating that an instance of a “Notify” action should be created, then the action management module 128 may create the discrete data record 134b, and populate the action-specific data 136b with the field(s) specified by the “Notify” action type definition 142b (e.g., a field for storing data representing a person to). The action creation input 126 may also contain data representing the values of one or more of the fields of the specified discrete data record type. For example, if the action creation input 126 specifies that a “Notify” discrete data record is to be created, the action creation input 126 may also contain data representing a person to notify. The action management module 128 may use such data in the action creation input 126 to populate the person field in the action-specific data 136b of the created discrete data record 132b.

It should be understood that the same or different action type definitions may be used to create additional discrete data records, such as discrete data record 134c (which contains thread ID field 134c and action-specific data 136c). Furthermore, it should be understood that the use of action type definitions is optional and does not constitute a limitation of the present invention. Furthermore, embodiments of the present invention may use action type definitions which are implemented in ways other than those disclosed herein. More generally, discrete data records may be generated in any of a variety of ways.

Once the discrete data records 134a-c have been created, the system 100 may perform any of a variety of tasks based on such discrete data records 134a-c. For example, the system 100 may generate a report based on the discrete data records 134a-c and display such a report to one or more of the users 104a-c. As another example, the system 100 may generate and provide (e.g., transmit and/or display) a message to one or more people associated with a discrete data record (such as the person specified by the person field of a “Notify” discrete data record) to notify such people of the discrete data record. Such messages may be deferred, such as in the case of providing a reminder for a “Follow Up” in some set period of time in the future (e.g., at a particular specified date and time, or a particular specified amount of time (e.g., one hour, day, or week) in the future, measured from the current time).

More generally, the action management module 128 may automatically perform the action(s) represented by a discrete data record (FIG. 2, operation 206). For example, automatically generating and providing a message represented by a “Notify” action data record is an example of automatically performing an action represented by the “Notify” discrete data record. Furthermore, as this example illustrates, the entity that performs the action represented by a discrete data record may be a human or a non-human (e.g., a computer or a computer program). For example, the notify action represented by a “Notify” discrete data record may be performed automatically by a computer. Contrast this with a “Follow Up” discrete data record, which represents a follow up action to be performed by a human. A discrete data record may, however, represent an action to be performed by a human user (such as a follow up action), but also cause the action management module 128 to perform one or more actions automatically (such as reminding the human user to perform the action represented by the discrete data record.)

Although the discrete data record store 130 is shown in FIG. 1 as a distinct store of records generated as a result of receiving action creation input from one or more of the users 104a-c of the system 100, this is merely an example and does not constitute a limitation of the present invention. The system 100 may, for example, store discrete data records 134 as data records in any system for managing tasks (sometimes called “to dos” or “reminders”), such as Microsoft Outlook, Apple Reminders, or any other such similar system. As a result, once the discrete data records 134a-c are created, they may be processed in any of the ways made possible by such systems.

Furthermore, the system 100 may create one or more of the action data records 134a-c automatically or semi-automatically based on one or more of the messages 116a-c, 120a, and 122a-d in the message store 112. For example and as noted above, although the action creation input 126 is shown in FIG. 1 as being distinct from the message input 106c, some or all of the action creation input 126 may be contained within the message input 106c. For example, consider the following embodiment. The user 104c may determine, based on some information in message thread 114a, that a person (whether one of the users 104a-c or someone who is not a user of the system 100) should perform an action. The user 104c may then post a new message (e.g., message 116c) to the same message thread 114a by providing message input 106c to the messaging module 102. As described above, the messaging module 102 may receive the message input 106c from the user 104c and, in response, generate and store the message 116c in the thread 114a.

The action management module 128 may generate a discrete data record (e.g., discrete data record 134a) in operation 204 of FIG. 2 based on the message 116c. For example, the action creation input 126 received in operation 202 may be a message, and the action management module 128 may parse some or all of the message 116c and generate the discrete data record 134a in operation 204 based on the results of the parsing.

The action management module 128 may use any of a variety of techniques to generate discrete data records based on messages. For example, the action management module 128 may process each message in response to creation of the message, in an attempt to create one or more discrete data records based on the message. In other words, the action management module 128 may detect that a new message has been created, and process the new message in response to the detection. As another example, the action management module 128 may process new messages in the message store 112 periodically, e.g., every second, every minute, or every hour.

The action management module 128 may require that data be stored within a message in a particular format or otherwise satisfy particular criteria to enable that data to be used as the basis for the creation of one or more discrete data records. For example, the action management module 128 may consider any text following a hashtag (“#”) and preceding particular separator text (e.g., spaces, punctuation, or parentheses/brackets) to represent a discrete data record type. In response to determining that a message contains a hashtag followed by text, the action management module 128 may create a discrete data record having a type whose name is equal to the text immediately following the hashtag. For example, if a message contains the text “#Notify”, the action management module 128 may generate, based on such text, a discrete data record of the “Notify” type.

The message may further contain text or other data representing data to be stored within the discrete data record itself. Consider the following example message text:

“Test Text&nbsp;
#[Notify:{‘FineAmount’:’15.25’,’DemoPersonLink’:’6’}];
#[FollowUp:{‘Date’:’4/10/2013 12:42 AM’,’Description’:’Follow Up
Text’}]”.

The action management module 128 may generate, based on such a message: (1) a discrete data record representing a “Notify” action having a “FineAmount” field with a value of 15.25 and a “DemoPersonLink” field with a value of 6; and (2) a discrete data record representing a “FollowUp” action having a “Date” field with a value of Apr. 10, 2013 at 12:42 AM and a “Description” field with a value of “Follow Up Text”. As this example illustrates, the action management module 128 may generate more than one discrete data record based on a single message.

The particular message formats described above, such as the use of hashtags to denote discrete data record types, are merely examples and do not constitute limitations of the present invention.

As can be appreciated from the example message above, messages containing data for use in creating discrete data records may be difficult for humans to read and write. As a result, embodiments of the present invention may use any of a variety of techniques to make such messages easier for humans to read and write. For example, the system 100 may render messages of the kind described above in user-friendly ways which omit various details of the underlying encodings. For example, the message shown above may be rendered to the user as follows:

Test Text #Notify #FollowUp Follow Up Text

In this example, the system 100 renders the plain text “Test Text” fully, but only renders the “#Notify” and “#FollowUp” portions of the discrete data record specifiers within the message, omitting the field names and values from each such discrete data record specifier, with the exception of the text “Follow Up Text.” Any rule, algorithm, style sheet, or other process may be used to render messages to the user in a user-friendly manner, such as the manner illustrated above. The system 100 may enable the user to obtain more information about the contents of the message, such as by clicking on “#Notify,” thereby causing the system 100 to display the fields and values of the “Notify” discrete data record specifier in the message.

Embodiments of the present invention may enable users 104a-c to generate messages, such as the one shown above, easily and without needing to write code within the message. For example, the system 100 may provide the users 104a-c with a graphical user interface via which may prompt the users 104a-c with the names of the fields of the discrete data record being created, and into which the users 104a-c may type or otherwise input values for those fields. For example, if the user 104c provides input 126 indicating that user 104c desires to create a “FollowUp” discrete data record (such as by clicking on a “FollowUp” button or by typing “#FollowUp” within a message), the system 100 may display a dialog box to the user 104c displaying: (1) the text “Date,” followed by a date input field or a calendar control; and (2) the text “Description,” followed by a text field. The user 104c may input the contents of the Date and Description field using such a dialog box. In response, the action management module 128 may create and populate a discrete data record of type “FollowUp” with the field values provide by the user 104c in the dialog box.

Embodiments of the present invention have a variety of advantages, such as the following. Users of social networking systems and other messaging systems enjoy the ability to communicate with each other quickly and easily. Such users often communicate with each other about important tasks that require followup actions to be taken. Such communications do not, however, necessarily facilitate taking such actions. For example, users often engage in such communications quickly, while traveling, and without easy access or any access to their task management systems. Although it is desirable in such situations to keep track of which actions need to be performed in light of the contents of communications among users, it can be prohibitively difficult, time-consuming, or even dangerous for users to engage in the additional manual steps required to create notifications, tasks, or other reminders of the actions needing to be performed. Embodiments of the present invention address these problems by providing fast and simple ways for users to generate discrete data records based on messages. In particular, embodiments of the present invention enable discrete data records to be generated in association with message threads based on data (i.e., free form text) within messages in the threads themselves, thereby enabling such messages to serve the dual purpose of communicating information among users and of serving as the basis for an automatically-generated discrete data record, and without requiring users to perform tasks outside of the message thread in order to enable such discrete data records to be generated.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(A) identifying action creation input in free form text of an electronic communication from a first user;
(B) identifying a predefined type of discrete data record from among a plurality of predefined types of discrete data records based on said action creation input; and
(C) creating a discrete data record of said predefined type from said action creation input, the discrete data record representing an action to be performed.

2. The method of claim 1:
wherein the action creation input in the free form text of the electronic communication from the first user specifies a second user assigned to the action to be performed; and
wherein the discrete data record contains data representing the second user assigned to the action to be performed.

3. The method of claim 2, further comprising:
(D) transmitting a notification of the discrete data record to the second user assigned to the action to be performed.

4. The method of claim 1, further comprising:
(D) performing the action to be performed represented by the discrete data record.

5. The method of claim 1, wherein the electronic communication from the first user comprises an instant message.

6. The method of claim 1, wherein the instant message comprises a social media instant message.

7. The method of claim 1, wherein the discrete data record comprises a thread identifier.

8. The method of claim 7, wherein (C) comprises generating the thread identifier based on data in the action creation input that specifies the thread identifier.

9. The method of claim 7, wherein (C) comprises generating the thread identifier based on a message with which the first user currently is interacting.

10. The method of claim 1, wherein the discrete data record comprises action-specific data including data associated with the action to be performed.

11. The method of claim 9, wherein the action-specific data is generated from data of the action creation input.

12. The method of claim 1, wherein the plurality of predefined types of discrete data records are defined by a plurality of action type definitions.

13. The method of claim 1, wherein the plurality of predefined types of discrete data records include at least one of a “Follow Up” discrete data record type and a “Notify” discrete data record type.

14. A system comprising at least one non-transitory computer-readable medium comprising computer program instructions executable by at least one computer process to perform a method, the method comprising:
(A) identifying action creation input in free form text of an electronic communication from a first user;
(B) identifying a predefined type of discrete data record from among a plurality of predefined types of discrete data records based on said action creation input; and
(C) creating a discrete data record of said predefined type from said action creation input, the discrete data record representing an action to be performed.

15. The system of claim 14:
wherein the action creation input in the free form text of the electronic communication from the first user specifies a second user assigned to the action to be performed; and
wherein the discrete data record contains data representing the second user assigned to the action to be performed.

16. The system of claim 15, wherein the method further comprises:
(D) transmitting a notification of the discrete data record to the second user assigned to the action to be performed.

17. The system of claim 14, wherein the method further comprises:
(D) performing the action to be performed represented by the discrete data record.

18. The system of claim 14, wherein the electronic communication from the first user comprises an instant message.

19. The system of claim 14, wherein the instant message comprises a social media instant message.

20. The system of claim 14, wherein the discrete data record comprises a thread identifier.

21. The system of claim 20, wherein (C) comprises generating the thread identifier based on data in the action creation input that specifies the thread identifier.

22. The system of claim 20, wherein (C) comprises generating the thread identifier based on a message with which the first user currently is interacting.

23. The system of claim 14, wherein the discrete data record comprises action-specific data including data associated with the action to be performed.

24. The system of claim 22, wherein the action-specific data is generated from data of the action creation input.

25. The system of claim 4, wherein the plurality of predefined types of discrete data records are defined by a plurality of action type definitions.

26. The system of claim 14, wherein the plurality of predefined types of discrete data records include at least one of a “Follow Up” discrete data record type and a “Notify” discrete data record type.
